(19) United States
(12) Patent Application Publication
(10) Pub. No.: US 2005/0263923 A1
(43) Pub. Date: Dec. 1, 2005

(54) Method of producing a self supporting form from a coating material

(76) Inventors: Noel P. Hopkins, Derby (GB); Joanne M. Shipton, Bristol (GB)

Correspondence Address: MANELLI DENISON & SELTER, 2000 M STREET NW SUITE 700, WASHINGTON, DC, 20036-3307, US

(21) Appl. No.: 11/106,526

(22) Filed: Apr. 15, 2005

(30) Foreign Application Priority Data
May 29, 2004 (GB) 0412097.8

(51) Int. Cl. B29C 31/00

(52) U.S. Cl. 264/81; 264/313

(57) ABSTRACT

A metal alloy in particulate form is plasma flame sprayed into an appropriately shaped depression 12 in a mould 10, so as to produce a coating test piece in a desired shape. The walls of the mould serve to constrain the affects of residual stresses generated by the combining of molten and semi molten particles, and so as a test piece results which is a more integral, self supporting structure than those produced hitherto.

Coating materials are used to cover the surfaces of metallic objects, so as to protect the objects from degradation when subjected to hostile working conditions. An example of such objects are the turbine blades that operate in a gas turbine engine.

It is the practise in some designs, to make turbine blades from a given material, and coat their aerofoil portions with another material more able to withstand the high temperature gases that flow over them. The coating layer is usually a metal alloy and is normally applied by the know technique of thermal spraying and is very thin. It is important to have some idea of the structural integrity of the coating itself, and the quality of its adhesion to the blades aerofoils prior to actual use thereon.

There are a number of difficulties when trying to obtain material data from coatings. Firstly coatings are generally too thin to gain useful results when the coating is attached to a substrate. Secondly the substrate can often be stronger and/or stiffer than the coating and the effects of the substrate contaminate the test results. Thirdly the coating produced by thermal spraying has a particulate structure with different properties to cast materials of the same composition, thus it is not possible to look up material data from a data book of predetermined compositions. Fourthly the coating itself may be composite material with complex properties, eg a mixture of metal and ceramic.

When making a coating test piece, it is known to provide a salt based flat slab, and to thermally spray a particulate coating material on to one of its surfaces. On contact with the target surface, the particle cool rapidly and contract. Molten particles following and contacting the semi cooled particles generate residual stresses in the coating material. If as some times happens, the bond between the coating and the slab is not sufficiently strong, the coating de-laminates. Further if the slab is not sufficiently stiff, again as sometimes happens, the aforementioned residual stresses can induce distortion in the coating and slab. The resulting poor quality coating layer, when removed from the slab has too frequently proved unable to maintain an integral self supporting form that would give sufficiently accurate indication of strength when stressed on a standard mechanical test machine.

The present invention seeks to provide an improved method of producing an integral self supporting form from particulate material.

According to the present invention a method of producing an integral self supporting test coating from particulate material comprises the steps of making a dissolvable mould having a depression therein which conforms to the desired shape and volume of said test coating, thermally spraying said particulate material into said depression on the dissolvable mould so as to overfill it, removing the excess material when solidified from the dissolvable mould so as to make the resulting exposed material surface flush with the relevant surface of said dissolvable mould, then dissolving the dissolvable mould away from the solidified test coating.

The invention will now be described by way of example and with reference to the accompanying drawings, in which;

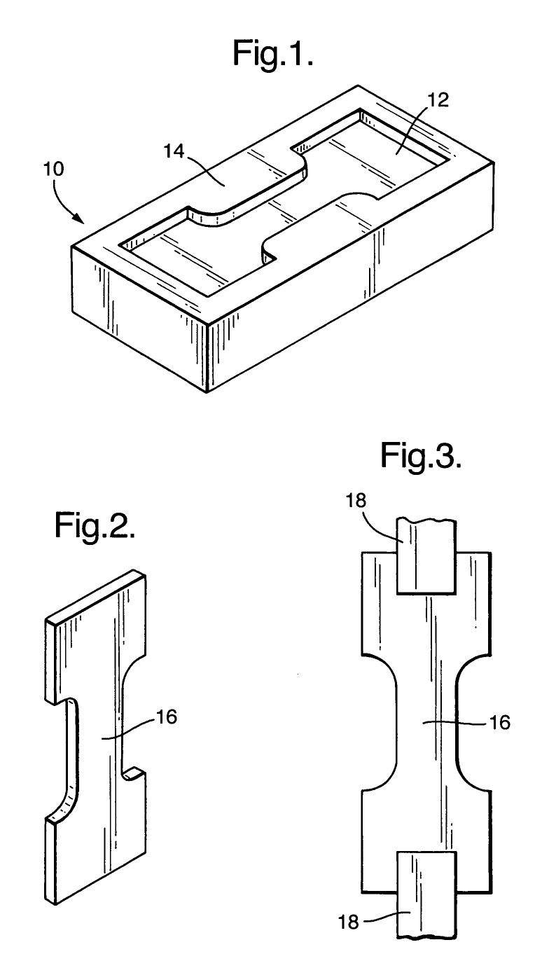

FIG. 1 is a pictorial view of a mould in accordance with the present invention.

FIG. 2 is a pictorial view of an integral self supporting test piece formed in the mould of FIG. 1.

FIG. 3 is a view of the test pieces of FIG. 2 in situ in a mechanical test rig.

Referring to FIG. 1 a sacrificial mould 10 has a depression 12 of a desired shape and depth formed in a surface 14. In the present example, a test piece 16 (FIG. 2) is produced by thermally spraying particles of molten metal into the depression 14. Spraying is performed long enough to overfill the depression 14, and when the metal has solidified, the excess is machined off so as to leave the exposed metal surface (not shown in FIG. 1) flush with the outer surface of the mould.

Sacrificial mould 10 is made from a dissolvable plaster that on completion of the thermal spraying and machining operations, can be placed in water, or depending on the kind of plaster, an acidic solution, and dissolved away from test piece 16.

Alternatively the sacrificial mould 10 may be made from a dissolvable plastic, or dissolvable plastic composite, that on completion of the flame spraying and machining operations, can be placed in water or an acidic solution and dissolved away from test piece 16. A suitable plastic is sold under the trade name AQUAPOUR.

A thermally sprayed coating test piece, when made by the moulding process described, illustrated and claimed in this specification, is more robust than hitherto, by virtue of the walls of the mould containing the sprayed coating and restricting the affect that the residual stresses have on the sprayed coating. The mould also allows the coating to be sprayed to near net shape, reducing the amount of subsequent machining. A consequence is that a coating test piece can be more easily handled, and when mechanically stressed on a standard mechanical testing machine 18, provides more reliable information regarding the strength of the coating.

The method of producing integral self supporting test coating may be used to produce a number of test coatings with different dimensions and/or shapes for mechanically testing, for example tensile testing, fatigue testing, creep testing or CT testing to obtain data, eg to measure, the tensile, fatigue, creep and CT properties and performance characteristics of the coating material. The mechanical testing may be used to determine Young's Modulus at one or more temperatures for each coating material, test coating, tested.

The present invention is applicable to the production of integral self supporting test coatings by any thermal spraying technique, for example plasma spraying, flame spraying, combustion spraying, HVOF spraying etc. The present invention is applicable to various coatings for example thermal barrier coatings, eg zirconia or yttria stabilised zirconia, or other suitable ceramics, metal bond coatings and environmental protective coatings, eg metal or alloys McrAlY, McrAl, wear erosion resistant coatings, eg WC and/or abradable coatings, composite of metal and ceramic.

1. A method of producing an integral self supporting test coating from particulate material comprises the steps of (i) making a dissolvable mould having a depression therein which conforms to a desired shape and volume of said test coating, (ii) thermally spraying said particulate material into said depression in the dissolvable mould so as to overfill it, (iii) removing the excess material when solidified from the dissolvable mould so as to make the exposed material surface flush with the relevant surface of said dissolvable mould, (iv) then dissolving the dissolvable mould away from the solidified test coating.

2. A method of producing an integral self supporting test coating from particulate material as claimed in claim 1 including the step of utilising a dissolvable plastic to form the dissolvable mould.

3. A method of producing an integral self supporting test coating from particulate material as claimed in claim 2 including the step of forming the dissolvable mould from a plastic that is dissolvable in water.

4. A method of producing an integral self supporting test coating from particulate material as claimed in claim 2 including the step of utilising a plastic composite to form the dissolvable mould.

5. A method of producing an integral self supporting test coating from particulate material as claimed in claim 1 including the step of forming the dissolvable mould from a substance that is dissolvable in an acidic fluid.

6. A method of producing an integral self supporting test coating from particulate material as claimed in claim 5 including the step of forming the dissolvable mould from plaster.

7. A method of producing an integral self supporting test coating from particulate material as claimed in claim 1 wherein the thermal spraying of said particulate material is selected from the group comprising plasma spraying, flame spraying, combustion spraying and HVOF spraying.

8. A method of producing an integral self supporting test coating from particulate material as claimed in claim 1 wherein the particulate material is selected from the group comprising a metal, an alloy, a ceramic and a composite of metal and ceramic.

9. A method of producing an integral self supporting test coating from particulate material as claimed in claim 1 wherein the test coating is selected from the group comprising a thermal barrier coating, an environmental protective coating, a wear resistant coating and an abradable coating.

10. A method of mechanically testing an integral self supporting test coating, comprising the steps of (a) producing the integral self supporting test coating from particulate material and step (b) mechanically testing the integral self supporting test coating to determine the mechanical properties of the coating material, wherein step (a) comprises the steps of (i) making a dissolvable mould having a depression therein which conforms to a desired shape and volume of said coating, (ii) thermally spraying said particulate material into said depression in the dissolvable mould so as to overfill it, (iii) removing the excess material when solidified from the dissolvable mould so as to make the exposed material surface flush with the surface of the dissolvable mould, and (iv) dissolving the dissolvable mould away from the solidified test coating.

11. A method of mechanically testing an integral self supporting coating as claimed in claim 10 wherein the mechanical testing is selected from the group comprising tensile testing, fatigue testing, creep testing and CT testing.
